(19) United States
(12) Patent Application Publication
(10) Pub. No.: US 2008/0195472 A1
(43) Pub. Date: Aug. 14, 2008

(54) ONLINE PURCHASE INCENTIVE METHOD AND SYSTEM

(76) Inventors: Richard Alan Shandelman, Lafayette Hill, PA (US); Shane Edward Brennan, Merchantville, NJ (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/674,295

(22) Filed: Feb. 13, 2007

(51) Int. Cl. G06Q 30/00

(52) U.S. Cl. 705/14

(57) ABSTRACT

A marketing method includes operating a central server to communicate with multiple, unrelated online storefront systems. The method receives a server request from a browser of a customer who is accessing one of the storefronts, and it determines if the browser corresponds to a customer having a profile in a customer profile database. If the customer has a profile in the customer profile database, the method returns at least a portion of the profile to the storefront. If the customer does not have a profile in the customer profile database, the method creates a profile for the customer. The method receives transaction information for the customer from the first storefront, updates the customer profile to create an updated profile based on the transaction information. In response to a request from a second storefront, the method provides the second storefront with at least a portion of the updated profile.

### CROSS-REFERENCE TO RELATED RESEARCH

Not applicable.

### STATEMENT REGARDING FEDERALLY SPONSORED RESEARCH

Not applicable.

### NAMES OF PARTIES TO A JOINT RESEARCH AGREEMENT

Not applicable.

### SEQUENCE LISTING

Not applicable.

### BACKGROUND

1. Technical Field

The disclosed embodiments generally relate to the field of product and service marketing methods and systems.

2. Description of the Related Art

Electronic commerce has rapidly grown to embody a significant portion of retail sales. However, with the many websites that are available and which compete for customers' attention, it is difficult for many electronic storefronts to attract customers. Some storefronts take the approach of offering a large number of products and services, or of aggregating multiple storefronts in a single website or online “mail” however, smaller stores and specialty retailers who want to participate in such a shopping community must conform to the guidelines of the community and often lose their individual look and feel, and thus the unique value and marketing cachet that they can provide.

On the other hand, small retailers or specialty stores can command significant brand loyalty to consumers, but consumers may tend to search for products on the smaller websites, and then price-compare those products with products offered on larger websites or malls. Thus, the smaller webstores who are successful in attracting customer attention many not be able to keep the customers that they initially attract.

Accordingly, what is needed is an improved system that allows online storefronts to maintain a unique identity while also being able to offer incentives that permit them to more effectively compete with larger storefronts and online malls.

The disclosure contained herein describes attempts to address one or more of the problems described above.

### SUMMARY

In an embodiment, a marketing method includes operating a central server to communicate with multiple, unrelated online storefront systems. The method receives a server request from a browser of a customer who is accessing one of the storefronts, and it determines if the browser corresponds to a customer having a profile in a customer profile database. If the customer has a profile in the customer profile database, the method returns at least a portion of the profile to the storefront. If the customer does not have a profile in the customer profile database, the method creates a profile for the customer. The method receives transaction information for the customer from the first storefront, updates the customer profile to create an updated profile based on the transaction information. In response to a request from a second storefront, the method provides the second storefront with at least a portion of the updated profile.

Optionally, the determining includes determining whether the browser has transmitted a token to the central server. If the customer does not have a profile in the customer profile database, the method also may include delivering a token to the browser. The profile, when returned to the first storefront, may include transaction history data for the customer. The transaction history data may include data from one or more storefronts other than the first storefront. The method also may include, if the customer has a profile in the customer database, providing the first storefront with a purchase incentive for the customer. The purchase incentive may be based at least in part on one or more prior transactions by the first customer at one or more storefronts other than the first storefront. The method also may include offering the customer a product, wherein the product has an attribute that is determined using the updated profile.

### BRIEF DESCRIPTION OF THE DRAWINGS

FIG. 1 is a block diagram of various aspects of an exemplary customer purchase incentive and product recommendation system.

FIG. 2 depicts exemplary elements of methods that may be implemented by the system of FIG. 1.

FIG. 3 describes an exemplary customer profiling process.

FIG. 4 describes an exemplary third party market data receiving process

FIG. 5 is a block diagram of exemplary internal hardware that may be used to contain or implement the program instructions according to an embodiment.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope. For example, as used herein and in the appended claims, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

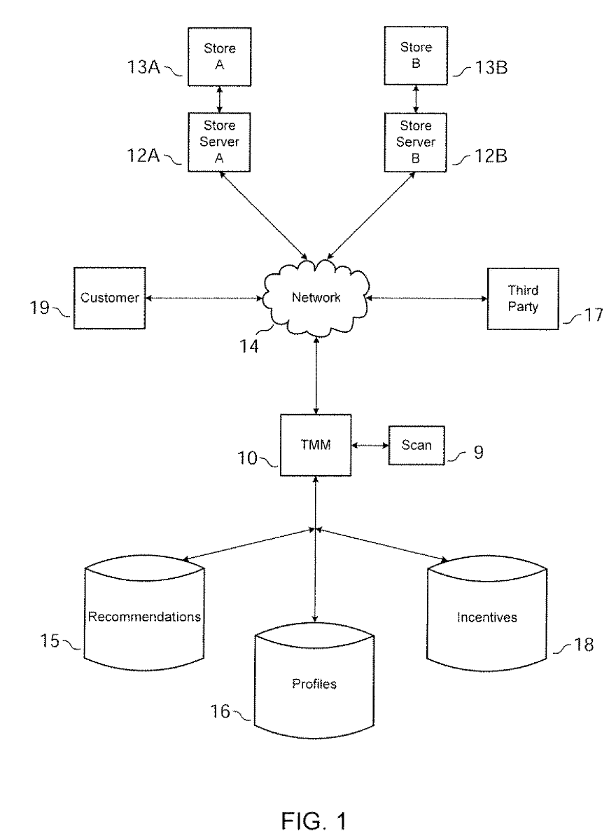

In accordance with one embodiment, as illustrated in FIG. 1, an online marketing system includes a central server 10 or system that implements the marketing system described herein. The central server 10 is referred to herein as the “TMM” to distinguish it from third party servers that may be operated by others or by the same entity in communication with the TMM. The TMM 10 communicates with any number of seller or e-store servers 12A, 12B via a communications network 14 such as the Internet, an intranet, or any network that permits interactive communication of graphics and text and optionally audio data. Each seller server 12A, 12B is used by an online merchant to implement an e-commerce storefront 13A, 13B such as an online shopping site, an auction site, a services delivery site, or another store that is made available through a web-based or other online system. At least two of the seller servers 12A, 12B and associated stores 13A, 13B are separate from each other, such that they do not share common ownership or any marketing relationship other than the relationship that they share with TMM 10. A customer 19 may access any seller storefront 13A, 13B via the communications network 14 and the storefront's associated seller server 12A, 12B. As used herein “customer” is any individual or entity that accesses a storefront for the purchase or potential purchase of a product or service.

TMM 10 includes or is in communication with a customer profile database 16 containing profile information relating to at least some of the customers 19 of one or more of the storefronts 13A, 13B. This profile information includes information relating to a customer identifier (such as a username, password, and/or token than uniquely identifies each customer) and a customer shopping history. For example, the customer identification may include information supplied by the customer, such as a customer name, geographic location, gender, or age. The customer identification may also include information regarding the customer's purchasing history or preferences, such as information relating to products and/or that the customer purchased or viewed for potential purchase from one or more of the storefronts 13.

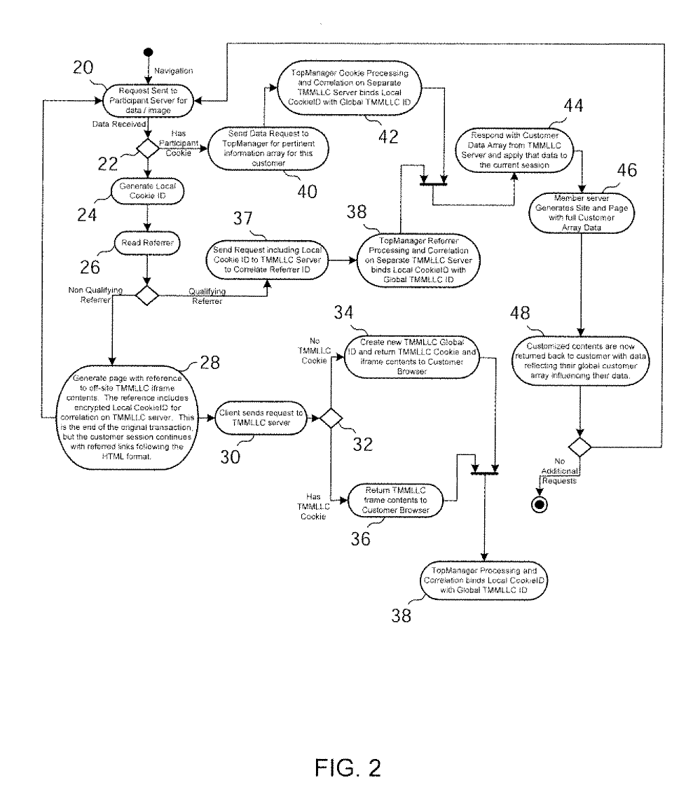

Referring to FIG. 2, a customer accesses 20 one of the storefronts using a browser or other software application. This occurs when the customer uses a browser on a client device to request information from a seller server. A “browser” is intended herein to refer to any software application that may display graphics and text received from another source through a communications network such as the Internet. The storefront or seller server will determine 22 if the customer has used the same browser to previously visit the storefront. The determination 22 occurs by determining if the customer request included a token, such as a cookie, that permits the storefront to recognize the customer as a previous user of the storefront.

If the customer request does not include a token 22, and storefront server thus does not receive a cookie or other token identifying, the customer has visited the storefront before using the same browser, then the storefront creates a new token 24, such as a new local cookie or other unique identifier that it passes to the customer as a new cookie, so that the storefront can later recognize the customer when the customer returns using the same browser. Before the store server returns the token to the customer, the store server may also analyze the request to determine whether the customer was referred by a referring entity 26 (such as by accessing the seller server using a link from another website) or if the customer directly accessed the seller server, such as by entering the universal reference locator (URL) or web address of the seller server's storefront.

The storefront then presents a storefront web page or other communication to the customer that enables the customer to view products and make purchase transactions. If the customer's original request included neither a cookie nor a reference to a referral, the storefront page includes an object, such as an HTML entity or embedded document, with an address or other reference that points to content contained on the TMM server as well as a encrypted version of the local cookie. Thus, the storefront server returns 28 token data such as a cookie, a storefront page, and an external reference to the TMM server to the customer.

The customer browser will continue to download objects from both the seller server and the TMM server until the page is “fully loaded” or all elements are downloaded and displayed to the customer. Therefore, the store server can assume that the customer browser will follow the link to the TMM server and attempt to get that entity 30. At this point, the conversation relating to that portion of the page is entirely between the TMM server and the client. The store server is not a party.

The TMM server will then determine 32 whether the customer has used the browser to access the TMM server before. If the customer browser has been referred to the TMMLLC server previously by another site, it will present global cookie data or another token to the TMM server. Since the TMM server is a central site, the cookie data presented may be linked to the global profile of that customer, and not to a particular site's data. A global cookie is used herein to refer to a token indicating that a customer browser has previously been referred to the TMM server. If there is a global cookie on that client machine, the new seller server unique id will be linked to the global data in the TMM server's database 36. If the customer does not have a global cookie, a new global cookie id is generated 34 and linked to the seller server unique ID. If the customer did not have any cookie at all, a new one is set by the TMM server, and the requested entity is sent back to the customer's browser from the TMM server.

If the client had been referred by another storefront server still without a local cookie, instead of sending the client a link to automatically follow the TMM server, the seller server may submit via encrypted back channel the referring URL and other identifying data, as well as the local generated unique cookie ID 37. This information is linked to the customer's global profile at the TMM server 38, if identifiable and the customer's profile information is returned to the storefront server. The profile may contain data relevant to customer purchase potential, such as purchasing habits, interests, applicable rewards, etc. The seller's storefront site is then generated with reference to this data.

If the storefront recognized the customer in step 22 because the storefront server received a participant token with the customer request, then the storefront may send a request to the TMM server to determine whether the customer has a profile in the database and if so, to return customer profile information 40. The TMM server may do this by determining relating to the local generated ID with the global ID 42 and returning some or all of the profile to the storefront 44. The storefront server may retain a local copy of the returned customer profile information while the session is active, deleting all data that has not been accessed for a set period of time. Optionally the TMM server returns only the elements of the profile that have changed since the last time that the customer accessed a TMM member storefront. Each time the profile is returned, the site would then he generated with the latest data. In this way, immediate rewards would be available for concurrent surfing on a multiple storefront server, where once the it original purchase was made any future navigation on the second site would have that additional information available.

The storefront server may perform actions such as presenting 46 a web page for the customer. The presenting may include a personalized message to the customer or presenting a product recommendation to the customer based on the information contained in the profile 48.

Preferably, all communications between a seller server and the TMM server that includes any customer profile data will be encrypted or otherwise shielded to provide secure transfer of data.

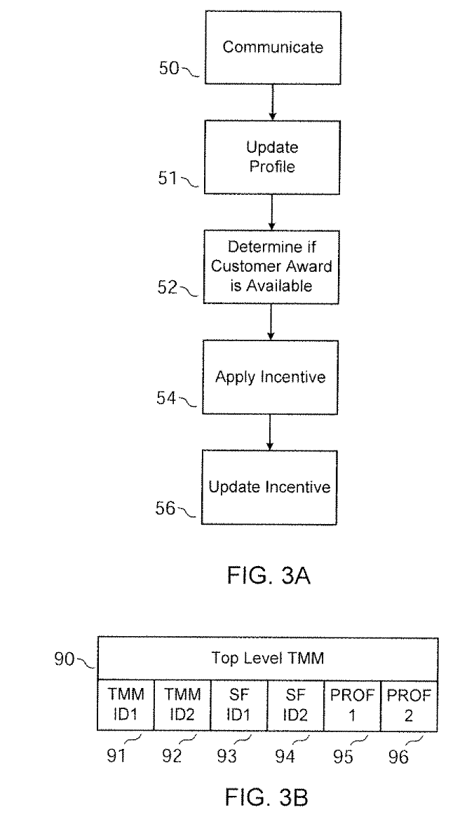

FIG. 3A illustrates exemplary ways in which the TMM server may correlate the local customer ID with the global 11) to step 42 in FIG. 2. Referring to FIG. 3A, as the customer communicates with the storefront, the storefront may communicate 50 with the TMM server to share and receive transaction and provide information. For example, after making the initial transaction, the storefront may receive customer identification information, such as a user name, address, credit card number, or other personally identifying information. Based on this information, the may server may determine that the customer matches an existing profile, and then the TMM server may update 51 the current or existing profile, merge the profiles, or otherwise correlate the customer date to ensure that a single record contains all current information for that customer. Such correlation may occur, for example, when an existing customer accesses a storefront using a new computer that does not yet have a TMM token stored in its browser. The TMM server also will update 51 a customer's profile based on products viewed, products purchased, and requests made at the storefront, which the storefront will pass along to the TMM server. Referring to FIG. 3B, the correlation may occur, for example, by storing a top-level TMM server customer identifier 90 in the customer profile database. Multiple additional customer profiles and identifiers may be associated with the top-level identifier 90, such as additional TMM server identifiers 91, 92, storefront identifiers 93, 94, and directions to the customers profile or profiles 95, 96. The TMM server may update any of these items at any time to make associate one customer identifier with another under a common top-level identifier 90. The correlation of information and updating of product profiles may occur in real time, as the customer transacts with one or more of the participating storefronts. Alternatively, the correlation may occur periodically, such as daily, or after a specified amount of new information is received.

In some embodiments, referring again to FIG. 1, the TMM server may provide the storefront with a purchase incentive record 18 for the customer. Purchase incentive records may be included in a separate database or the same database as the customer profile 16. The purchase incentive records may include, for example, a discount or credit that can be used at some or all of the storefronts that are in communication with the central server. The records may be maintained in a customer account, such as a “promotional dollars” account that the customer can use for purchases at multiple storefronts.

The purchase incentive records may be implemented by a rewards module that allows the TMM server to communicate with the multiple storefronts, offer the purchase incentive for purchases from the multiple storefronts, and update the purchase incentives based on the customer's purchases at any of the storefronts. For example, referring again to FIG. 1 and FIG. 3, if the customer makes a purchase at one of the storefronts 13A, the rewards module may determine if the customer has a reward available 52, and the reward may be applied to a purchase 54 at a different storefront 13B. The customer's incentive or reward account may be periodically updated 56. For example, the account may be increased to give the customer a credit or discount that is determined based on the amount or the type of product or service that the customer purchased at any of the storefronts 13A, 13B, etc. in the system. Additional purchases may result in greater rewards being given to the customer. Optionally, some or all of the rewards may expire if the customer does not use the rewards within a predetermined period of time.

In some embodiments, referring again to FIG. 1, the TMM server may also include or access a recommendations module 15. The recommendations module 15 may include a product database 15 containing information that identifies products offered for sale by at least one of the sellers' storefronts 13A, 13B. The recommendations module may use information from the customer profile to determine what products the customer viewed and/or similar products at other storefronts who participate in the TMM server's system. The recommendations may be for the same products, similar products, or related ancillary products. For example, if the customer profile 16 indicates that customer 19 purchased a guitar from storefront 13A, the TMM server may tell a different storefront 13B that the customer may be interested in products related to guitars, such as sheet music or guitar strings. In this manner, storefront 13B can provide the customer with personalized product recommendations based on the customer's previous shopping history, even if the customer has never visited storefront 13B in the past.

In some embodiments, the customer profile includes one or more customer demographics. Customer demographics may include customer city and, or state, or information personal to the customer based on the customer's purchase history. For example, if the customer has purchased baby equipment and clothing, the demographic may indicate that the customer is a parent of a young child. The recommendation system may then provide recommendations for products that may be of interest to—or which have been purchased by—customers having a similar demographic profile.

Optionally, in embodiments where both a product recommendation module and a rewards module are available, the customer may be offered both an ancillary product and a reward based on the customer's available incentives. Optionally, the reward may be greater, such as larger discount or credit, if applied to the purchase of the ancillary product.

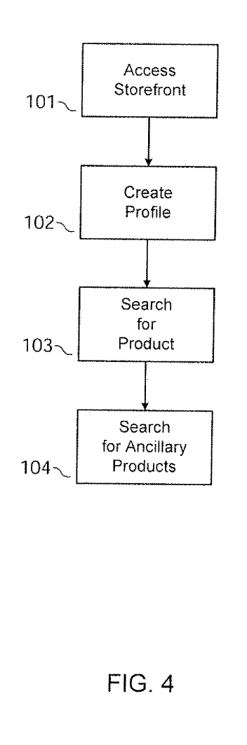

In some embodiments referring to FIG. 1, the TMM server may implement a scanning module 9 that uses the communications network 15 to periodically review information published by a third party seller 17, such as an e-commerce website that does not participate in the central server's rewards system, and/or optionally websites of one or more sellers who do participate in the rewards system. FIG. 4 illustrates an exemplary scanning module process, in which the system emulates a customer by automatically accessing a third party storefront 101, creating a profile 102 on that storefront if required, and requesting information 103 relating to one or more products that are known to be sold by one or more of the sellers who subscribe to the TMM system. The review may review the third party storefront to identify, for the requested product one or more ancillary products 104 that are recommended by the third party storefront to the TMM server when emulating a human purchaser.

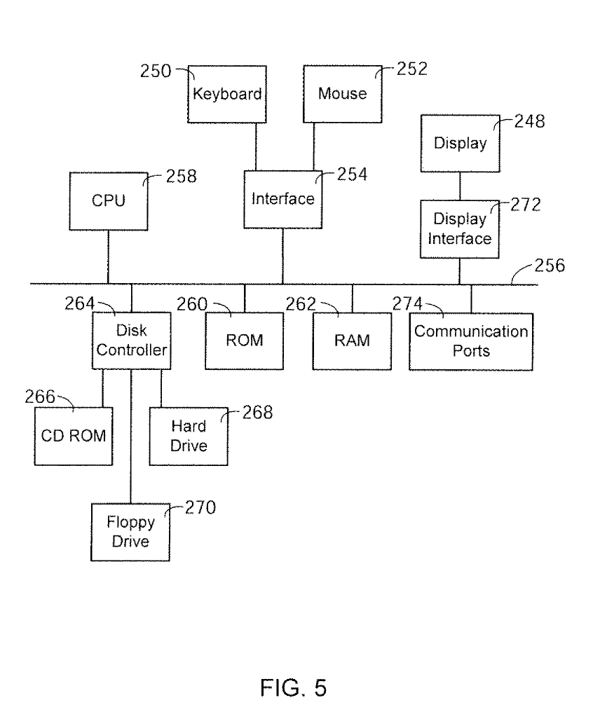

FIG. 5 is a block diagram of exemplary hardware that may be used to contain and/or implement the program instructions of a system embodiment. Of course, any electronic device capable of carrying out instructions contained on a carrier such a memory, signal, or other device capable of holding or storing program instructions may be within the scope described herein. Referring to FIG. 5, a bus 228 serves as the main information highway interconnecting the other illustrated components of the hardware. CPU 202 is a central processing unit of the system, performing calculations and logic operations required to execute a program. Read only memory (ROM) 218 and random access memory (RAM) 220 constitute exemplary memory devices.

A disk controller 204 may interface with one or more optional disk drives to the system bus 228. These disk drives may be external or internal memory keys, zip drives, flash memory devices, or other memory media such as 210, CD-ROM drives 206, or external or internal hard drives 208. As indicated previously, these various disk drives and disk controllers are optional devices.

Program instructions may be stored in the ROM 218 and/or the RAM 220. Optionally, program instructions may be stored on a computer readable medium such as a floppy disk or a digital disk or other recording medium, a communications signal or a carrier wave.

An optional display interface 222 may permit information from the bus 228 to be displayed on the display 224 in audio, graphic or alphanumeric format. Communication with external devices may optionally occur using various communication ports 226. An exemplary communication port 226 may be attached to a communications network, such as the Internet or an intranet.

In addition to the standard computer-type components, the hardware may also include an interface 212 which allows for receipt of data from input devices such as a keyboard 214 or other input device 216 such as a remote control, pointer and/for joystick. A display including touch-screen capability may also be an input device 216. An exemplary touch-screen display is disclosed in U.S. Pat. No. 4,821,029 to Logan et al., which is incorporated herein by reference in its entirety.

An embedded system may optionally be used to perform one, some or all of the operations of the methods described. Likewise, a multiprocessor system may optionally be used to perform one, some or all of the methods described.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A marketing method, comprising:
operating a central server that is in electronic communication with a plurality of online storefront systems, wherein at least two of the online storefront systems do not share common ownership and operation;
receiving a server request from a browser of a customer who is accessing a first one of the storefronts;
determining if the browser corresponds to a customer having a profile in a customer profile database;
if the customer has a profile in the customer profile database, returning at least a portion of the profile to the first storefront;
if the customer does not have a profile in the customer profile database, creating a profile for the customer;
receiving transaction information for the customer from the first storefront;
updating the customer profile to create an updated profile based on the transaction information;
in response to a request from a second storefront, providing the second storefront with at least a portion of the updated profile.

2. The method of claim 1, wherein the determining comprises determining whether the browser has transmitted a token to the central server.

3. The method of claim 1, wherein, if the customer does not have a profile in the customer profile database, the method also includes delivering a token to the browser.

4. The method of claim 1, wherein the profile, when returned to the first storefront, includes transaction history data for the customer, the transaction history data including data from one or more storefronts other than the first storefront.

5. The method of claim 1, further comprising, if the customer has a profile in the customer database, providing the first storefront with a purchase incentive for the customer

6. The method of claim 5, wherein the purchase incentive is based at least in part on previous transactions by the first customer at one or more storefronts other than the first storefront.

7. The method of claim 1, further comprising offering the customer a product, wherein the product has an attribute that is determined using the updated profile.

8. A marketing method, comprising:
operating a central server that is in electronic communication with a plurality of online storefront systems, wherein at least two of the online storefront systems do not share common ownership and operation;
receiving a server request from a browser of a customer who is accessing a first one of the storefronts;
determining if the browser corresponds to a customer having a profile in a customer profile database by determining whether the browser has transmitted a token to the central server;
if the customer has a profile in the customer profile database, returning at least a portion of the profile to the first storefront;
if the customer does not have a profile in the customer profile database, creating a profile for the customer and delivering a token to the browser;
receiving transaction information for the customer from the first storefront;
updating the customer profile to create an updated profile based on the transaction information;
in response to a request from a second storefront, providing the second storefront with at least a portion of the updated profile.

9. The method of claim 8, wherein the profile, when returned to the first storefront, includes transaction history data for the customer, the transaction history data including data from one or more storefronts other than the first storefront.

10. The method of claim 8, further comprising, if the customer has a profile in the customer database, providing the first storefront with a purchase incentive for the customer.

11. The method of claim 10, wherein the purchase incentive is based at least in part on previous transactions by the first customer at one or more storefronts other than the first storefront.

12. The method claim 8, further comprising offering the customer a product, wherein the product has an attribute that is determined using the updated profile.

13. A marketing method, comprising:
operating a central server that is in electronic communication with a plurality of online storefront systems, wherein at least two of the online storefront systems do not share common ownership and operation;
receiving a server request from a browser of a customer who is accessing a first one of the storefronts;
determining if the browser corresponds to a customer having a profile in a customer profile database by determining whether the browser has transmitted a token to the central server;
if the customer has a profile in the customer profile database, returning at least a portion of the profile to the first storefront, wherein the profile when returned to the first storefront includes transaction history data for the customer, the transaction history data including data from one or more storefronts other than the first storefront;
if the customer has a profile in the customer profile database, also providing the first storefront with a purchase incentive for the customer
receiving transaction information for the customer from the first storefront;
updating the customer profile to create an updated profile based on the transaction information;
in response to a request from a second storefront providing the second storefront with at least a portion of the updated profile.

14. The method of claim 13, further comprising, if the customer does not have a profile in the customer profile database, creating a profile for the customer and delivering a token to the browser;

15. The method of claim 10, wherein the purchase incentive, if provided, is based at least in part on previous transactions by the first customer at one or more storefronts other than the first storefront.

16. The method of claim 15, further comprising offering the customer a product, wherein the product has an attribute that is determined using the updated profile
